(19) United States
(12) Patent Application Publication
(10) Pub. No.: US 2013/0168224 A1
(43) Pub. Date: Jul. 4, 2013

(54) LEVERAGE OF WASTE PRODUCT TO PROVIDE CLEAN WATER

(71) Applicant: Ned Godshall, Albuquerque, NM (US)

(72) Inventor: Ned Godshall, Albuquerque, NM (US)

(73) Assignee: Altela. Inc., Albuquerque, NM (US)

(21) Appl. No.: 13/514,900

(22) PCT Filed: Oct. 22, 2010
(86) PCT No.: PCT/US2010/053839

§ 371 Date: Jul. 10, 2012

Related U.S. Application Data
(60) Provisional application No. 61/254,619, filed on Oct. 23, 2009.
(60) Provisional application No. 61/254,613, filed on Oct. 23, 2009.

(51) Int. Cl. C02F 1/14; C02F 1/16

(52) U.S. Cl. CPC C02F 1/14; C02F 1/16
USPC 203/10; 202/183; 202/172

(57) ABSTRACT

Systems for efficient generation of clean water from non-potable water leverage heat provided by concentrated solar power or waste heat is co-located at a source of non-potable water for efficient, low-cost operation based on steam provided by the source of heat. A process of using such systems operated by the steam provided and the non-potable water, is disclosed, to generate clean water and concentrate water.

### RELATED APPLICATION

This application claims the full Paris Convention benefit of and priority to U.S. Provisional Patent Application Ser. No. 61/254,613, filed Oct. 23, 2009, U.S. Provisional Patent Application Ser. No. 61/254,619, filed Oct. 23, 2009, the contents of which are incorporated by reference herein in its entirety, as if fully set forth herein.

### BACKGROUND

### Field

This disclosure pertains to devices, processes, methods and systems which are related to, or arising from, the use of off the grid power to treat contaminated and/or non-potable water.

### SUMMARY

According to some exemplary implementations, disclosed is a system comprising: a solar-powered thermal heating device configured to transfer heat from captured solar power to a steam source; a humidification/dehumidification device configured to distill non-potable water into clean water; a steam supply line connecting the steam source to the humidification/dehumidification device; a non-potable water source connected to the humidification/dehumidification device by a non-potable water supply line; a clean water reservoir connected to the humidification/dehumidification device by a clean water outlet line; a concentrate water reservoir connected to the humidification/dehumidification device by a concentrate water outlet line.

The humidification/dehumidification device may further comprise at least one of a controller, a pump, and a blower. The at least one of a controller, a pump, and a blower may be powered by a solar-powered photovoltaic device.

The system may further comprise a high-temperature fluid storage device configured to transfer heat from a fluid of the solar-powered thermal heating device to the steam source via a heat exchanger.

The humidification/dehumidification device may comprise: a condensation chamber; an evaporation chamber; a heat transfer wall between the condensation chamber and the evaporation chamber. The steam supply line may be connected to the condensation chamber; the non-potable water supply line may be connected to the evaporation chamber; the clean water outlet line may be connected to the condensation chamber; the concentrate water outlet line may be connected to the evaporation chamber. The humidification/dehumidification device may further comprise: a dry carrier gas line connecting an outlet of the condensation chamber with an inlet of the evaporation chamber; saturated carrier gas line connecting an outlet of the evaporation chamber with an inlet of the condensation chamber.

The system may be co-located with a non-potable water source having no electrical power supply.

According to some exemplary implementations, disclosed is a method comprising: co-locating a humidification/dehumidification device with a non-potable water source having no electrical power supply; collecting heat from a solar-powered thermal heating device to generate steam; providing the steam and non-potable water from the non-potable water source to the humidification/dehumidification device; operating the humidification/dehumidification device with the steam, whereby the non-potable water is separated into distilled water and concentrate water.

Operating the humidification/dehumidification device may comprise: combining the steam with a saturated carrier gas in a condensation chamber of the humidification/dehumidification device; generating the distilled water and a dry carrier gas; combining the dry carrier gas with the non-potable water in an evaporation chamber of the humidification/dehumidification device; generating concentrate water and the saturated carrier gas.

Operating the humidification/dehumidification device may further comprise: transferring at least some of the heat from the condensation chamber to the evaporation chamber. The humidification/dehumidification device may be operated at about atmospheric pressure. The method may be performed by a system operating exclusively on solar power.

According to some exemplary implementations, disclosed is a system comprising: a waste heat source configured to transfer waste heat to a steam source; a humidification/dehumidification device configured to distill non-potable water into clean water; a steam supply line connecting the steam source to the humidification/dehumidification device; a non-potable water source connected to the humidification/dehumidification device by a non-potable water supply line; a clean water reservoir connected to the humidification/dehumidification device by a clean water outlet line; a concentrate water reservoir connected to the humidification/dehumidification device by a concentrate water outlet line.

The system may be co-located with a facility that includes the waste heat source and the non-potable water source.

According to some exemplary implementations, disclosed is a method comprising: co-locating a humidification/dehumidification device with a facility that includes a waste heat source and a non-potable water source; collecting waste heat from the waste heat source to generate steam; providing the steam and non-potable water to the humidification/dehumidification device; operating the humidification/dehumidification device with the steam, whereby the non-potable water is separated into distilled water and concentrate water.

According to some exemplary implementations, disclosed is a module for distillation, comprising: a plurality of distillation towers configured to distill clean water from non-potable water; a main supply air line connected to a supply air line of each of the plurality of distillation towers; a main exhaust air line connected to an exhaust air line of each of the plurality of distillation towers; a heat exchanger configured to exchange heat between the main exhaust air line and the main supply air line.

Each of the plurality of distillation towers may comprise: a condensation chamber; an evaporation chamber; and a heat transfer wall between the condensation chamber and the evaporation chamber; a steam supply line connected to the condensation chamber; a non-potable water supply line connected to the evaporation chamber; a clean water outlet line connected to the condensation chamber; a concentrate water outlet line connected to the evaporation chamber; saturated carrier gas line connecting an outlet of the evaporation chamber with an inlet of the condensation chamber; the supply air line connected to the evaporation chamber; the exhaust air line connected to the condensation chamber;

According to some exemplary implementations, disclosed is a method, comprising: providing supply air to a module having a plurality of distillation towers; separating the supply air among the plurality of distillation towers; in each of the plurality of distillation tower, generating distilled water, concentrate water, and exhaust air from produced water, steam, and the supply air; combining the exhaust air from the plurality of distillation towers; transferring heat from the exhaust air to the supply air.

The generating step may comprise: combining the supply air with the produced water in an evaporation chamber of the distillation tower; generating the concentrate water and a saturated carrier gas; combining the steam with the saturated carrier gas in a condensation chamber of the distillation tower; generating the distilled water and the exhaust air.

Other features and advantages of the present disclosure will be set forth, in part, in the descriptions which follow and the accompanying drawings, wherein the implementations of the present disclosure are described and shown, and in part, will become apparent to those skilled in the art upon examination of the following description taken in conjunction with the accompanying drawings or may be learned by practice of the present disclosure. The advantages of the present disclosure may be realized and attained by means of the instrumentalities and combinations particularly pointed out in the disclosure and any appended claims.

Real-world technology demonstrations will advance the Energy and Environment missions of (i) promoting energy efficiency, by using low-grade waste heat from power plants and industrial processes that is currently being discarded to no benefit; (ii) enhancing U.S. energy security, by using more energy wisely at home, and providing secure and sustainable water supplies for the U.S. at no net energy use increase; (iii) promoting U.S. competitiveness and restoring science leadership, by implementing on a large scale the unique new HDH technology that enables low-cost water desalination without using pressure, expensive metal pressure vessels, and electricity to drive desalination pumps; and (iv) reducing global-warming gases and the need to build more fossil fuel electric plants for huge future desalination plants, by instead implementing—the re-use of energy that is currently being 100% discarded presently.

San Diego, Calif. has spent 8 years planning to build a typical pressurized RO desalination plant, replete with its long train of pre-treatment and post-treatment steps, for an estimated cost exceeding $85 M. This plant, when finished, will treat 50 million gallons/day of ocean water (150 acre-feet/day) using large amounts of electricity from the Carlsbad power station. This RO plant should make slightly less water than would the hypothetical 500 MW plant disclosed herein. However, the HDH process plant as discussed herein is far simpler. The San Diego plant will use >$100,000/day of electricity to run its pressure pumps, and use >1.25 MWH of electricity each day—both of which are obviated using the simpler process proposed here for the direct use of a power plant's waste heat. This single desalination plant in San Diego will therefore require an additional 456 MWH of electrical generation, at a direct cost of >$36M/year and large additional carbon-dioxide generation.

According to some exemplary implementations, disclosed is a produced water (“PW”) recycling facility designed to accept produced water from oil or gas wells. From this, it will generate very clean, potable quality water and water that has a high concentration of salts. The feed stock for this process will be the produced water generated by natural gas wells during the production of natural gas in the local area.

### DRAWINGS

The above-mentioned features of the present disclosure will become more apparent with reference to the following description taken in conjunction with the accompanying drawings wherein like reference numerals denote like elements and in which:

FIG. 1 shows a diagram of a humidification/dehumidification device, according to some exemplary implementations of the present disclosure;

FIG. 2 shows a diagram of a humidification/dehumidification device, according to some exemplary implementations of the present disclosure;

FIG. 3 shows a diagram of a solar-powered system, according to some exemplary implementations of the present disclosure;

FIG. 4 shows a diagram of a waste heat-powered system, according to some exemplary implementations of the present disclosure;

FIG. 5 shows a diagram of a system comprising a plurality of modules, according to some exemplary implementations of the present disclosure;

FIG. 6 shows a diagram of a distillation tower of a module, according to some exemplary implementations of the present disclosure;

FIG. 7 shows a view of a module comprising a plurality of distillation towers, according to some exemplary implementations of the present disclosure;

FIG. 8 shows a view of a module without its plurality of distillation towers, according to some exemplary implementations of the present disclosure;

FIG. 9 shows a view of a heat exchanger of a module, according to some exemplary implementations of the present disclosure; and

FIG. 10 shows a view of a heat exchanger of a module, according to some exemplary implementations of the present disclosure.

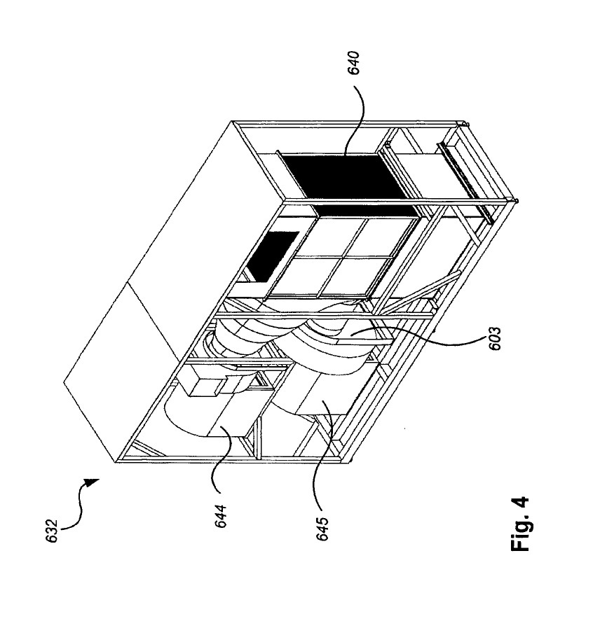

### FURTHER DESCRIPTION

As used herein, “waste heat” means heat that is no longer useful to the process by which it was generated. Waste heat is heat that would otherwise be dissipated, released, or not used by the process of its origin.

As used herein, “electrical power supply” means a readily available source of electrical power.

As used herein, “non-potable water” means water that is not of sufficiently high quality for consumption by persons. “Non-potable water” includes “brackish water” and “produced water.”

Each of U.S. Pat. No. 6,911,121, issued on Jun. 28, 2005; PCT App. Ser. No. PCT/US00/20366 (published as WO/2001/010101 on Aug. 2, 2001); and U.S. application Ser. No. 11/859,731 (published as U.S. Pub. No. 2008/0073200 on Mar. 27, 2008) are expressly incorporated herein by reference, as if fully set forth herein.

The important role of water in generating U.S. electrical power is often under-appreciated. The energy/water nexus is aggravated by large amounts of energy required to clean and transport water. Over half the energy of conventional power plants (including utility-scale CSP solar installations) becomes waste heat (not electricity) rejected into the atmosphere by power plant cooling towers. This disclosure demonstrates the novel use of this low-grade waste heat to desalinate brackish water using no new energy, thereby making a transformational leap by providing clean potable water from energy that is otherwise wasted. Implementations of the present disclosure uses low-temperature heat from spent steam, that is compatible with water desalination processes, and integrates the two in field demonstrations at both a concentrated solar power installation and a conventional electric generation power plant. Implementations of water purification products disclosed herein operate entirely on waste heat, rather than electricity. An example of such a process is the AltelaRain^{SM} process by Altela, Inc. (Albuquerque, N. Mex.).

A significant amount of energy in the U.S. is required for water transportation, purification, desalination, etc.—and that very large amounts of water in the U.S. are required for the generation of energy (electric power, oil and gas production and refining, mining of coal and uranium, etc.). This is commonly referred to as the “Energy/Water Nexus”—a huge amount of U.S. energy is consumed in providing clean drinkable water to Americans, and at the same time huge amounts of America's water is consumed in making and delivering energy to its citizens.

The production of electrical energy produces vast amounts of waste heat. At best, approximately 55% of all input energy into electric-generation power plants leaves the plant as low-grade waste heat. That is, only approximately 45% of the input energy is converted to electrical power for most large coal-fired power plants in the U.S. today. This is dictated by established thermodynamic laws, and the upper limit of efficiency conversion from fuel-to-electric power is given by the Carnot cycle efficiency—and is true regardless of the fuel type (coal, nuclear, diesel, natural gas or even new concentrated solar power) used to generate the steam that turns the plant's steam turbines. That is, over half of all the fuel used to generate electricity in the U.S. is “wasted”, in that it leaves the power plant's cooling towers in the form of low-temperature waste heat; energy that is never used productively. Those cooling towers themselves then use vast amounts of water, further exacerbating the U.S.'s energy/water nexus, especially in the arid west. Even the new utility-scale concentrated solar power (“CSP”) installations, beneficial because they do not use fossil fuels to generate steam, suffer from this same basic Carnot limitation—resulting in up to 60% of their incident solar energy also being lost in the cooling cycle downstream of their steam turbines.

In some exemplary implementations the low-grade, low-temperature, waste heat from energy generation is used to at least one of purify water for consumption and desalinate inland brackish and ocean waters. By doing so, “both halves” of the energy/water nexus can be improved substantially—making a transformational leap in providing more clean potable water by using energy that is otherwise wasted into the atmosphere. Disclosed herein is a water desalination technology which can operate substantially on waste heat, rather than electricity. Low-cost water desalination can be achieved from the low-grade waste heat given off from both conventional power plants and also the burgeoning new utility-scale CSP solar installations.

Desalination of brackish inland waters or ocean waters has historically been very energy intensive. Existing desalination technologies further aggravate the energy/water nexus because they all use electricity to accomplish the desalination process. This electrical energy requires, in turn, large amounts of water to make that electricity, as described above, in a vicious, never-ending cycle.

Traditional water desalination processes all use both pressurized vessels and large amounts of electricity, so none of them are compatible with the use solely of such waste heat—heat that is rejected at near-ambient pressure and near-ambient temperatures (˜the boiling point of water or less). Typically, the ˜55% of a power plant's energy that is rejected is in the form of near-ambient pressure steam entering the plant's cooling towers.

These traditional desalination technologies use pressure to accomplish the separation of water from the dissolved salts. Both membrane-based desalination technologies (e.g., reverse osmosis) and non-membrane-based desalination technologies (e.g., multi-stage flash and mechanical vapor compression) all operate at pressures above atmospheric. Some of the latter older non-RO desalination technologies also use waste heat, but—being pressurized—they also require very large amounts of electricity as well. Electricity is required to run the large pumps that are used to generate the required pressure. Beyond the innate high cost of electricity to operate the process, this reliance on pressure also then mandates a high capital cost infrastructure as well because the use of pressure demands a pressure vessel, which must be composed of exotic and expensive metals to both (a) withstand the pressure and (b) reduce corrosion from the brackish water that is being desalinated. Both capital costs and operating costs are therefore high with all present desalination technologies.

Disclosed herein is a unique technology that obviates the above high capital and operating costs by reversing the conventional wisdom that all water desalination processes must use pressure to accomplish the goal. The disclosed process does not require pressure above atmospheric. It therefore can be made of inexpensive plastics, since no pressure gradient needs to be withstood. Since the whole process is non-pressurized, all valves, pipes, tanks, etc. are therefore made from inexpensive plastics as well. Such plastics also have the added advantages of not fouling or scaling as metals do, and not corroding as metals do.

Disclosed herein is a thermal distillation process and device herein referred to as humidification/dehumidification (“HDH”). HDH mimics the same process used by nature to make rain water from non-potable saline ocean water. It is the world's only economically viable water desalination process that requires neither pressure nor high temperatures. According to some exemplary implementations, operating temperatures are below about 212° F. (100° C.). An HDH device may have no moving mechanical parts. It is not a membrane-based process, like RO and so it has no nanometer size pores to foul or become blocked. Its smallest channel size is 1,000,000 times larger than RO membrane pore sizes, so that it is extremely robust and tolerates mixed-contaminant, highly-challenged brackish waters that would instantly foul other water desalination equipment. An HDH process requires no pre-treatment or post-treatment steps, and it can desalinate brackish water four times more salty than the salinity that RO membranes can tolerate.

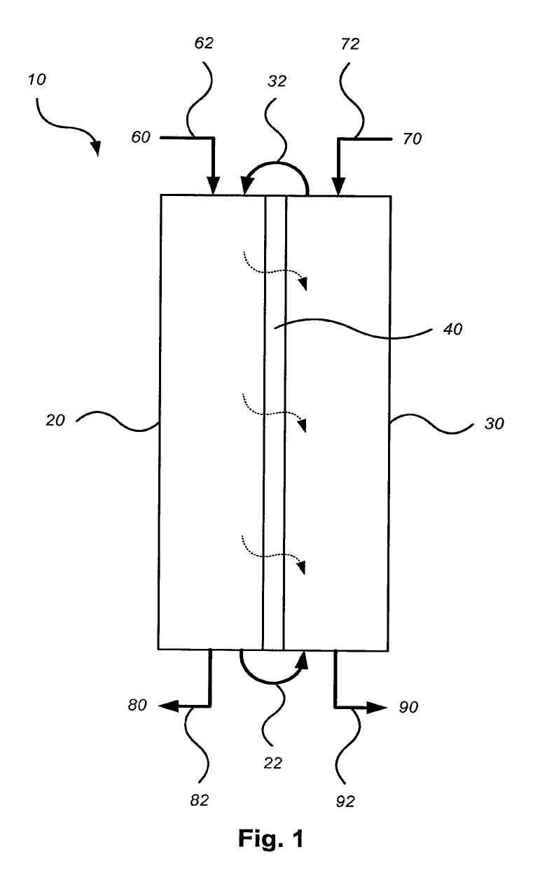

According to some exemplary implementations, as shown in FIG. 1, humidification/dehumidification device 50 distills clean water from non-potable water. HDH device 50 includes condensation chamber 20 and evaporation chamber 30. Heat transfer wall 40 divides at least portions of condensation chamber 20 and evaporation chamber 30 and is configured to transfer heat between the two chambers. Heat transfer wall 40 is otherwise impermeable.

According to some exemplary implementations, as shown in FIG. 1, steam supply line 62 connects steam source 60 to an inlet of condensation chamber 20. Steam source 60 may be one or more of a variety of steam-producing components, as disclosed further herein. Non-potable water supply line 72 connects non-potable water source 70 to an inlet of evaporation chamber 30.

According to some exemplary implementations, as shown in FIG. 1, clean water outlet line 82 connects clean water reservoir 80 to an outlet of condensation chamber 20. Clean/distilled water from condensation chamber 20 may be potable and usable in a variety of applications. Clean/distilled water from condensation chamber 20 may be provided to one or more locations and be used for a variety of purposes. For example, at least a portion of clean/distilled water from condensation chamber 20 may be recycled as steam via steam supply line 62. By further example, at least a portion of clean/distilled water from condensation chamber 20 may be stored in clean water reservoir 80.

According to some exemplary implementations, as shown in FIG. 1, concentrate water outlet line 92 connects concentrate water reservoir 90 to an outlet of evaporation chamber 30. Concentrate water from evaporation chamber 30 may be a solution of water and contaminants from the non-potable water. The concentrate water may be of higher concentration than the non-potable water. Concentrate water may be provided for further processing, storage, disposal, etc.

According to some exemplary implementations, as shown in FIG. 1, dry carrier gas line 22 connects an outlet of condensation chamber 20 to an inlet of evaporation chamber 30. Dry carrier gas may contains contents of condensation chamber 20 not directed to clean water outlet line 82. Dry carrier gas from condensation chamber 20 may transfer heat as it is provided from condensation chamber 20 to evaporation chamber 30.

According to some exemplary implementations, as shown in FIG. 1, saturated carrier gas line 32 connects an outlet of evaporation chamber 30 to an inlet of condensation chamber 20. Saturated carrier gas from evaporation chamber 30 contains a separable liquid component to be separated in condensation chamber 20.

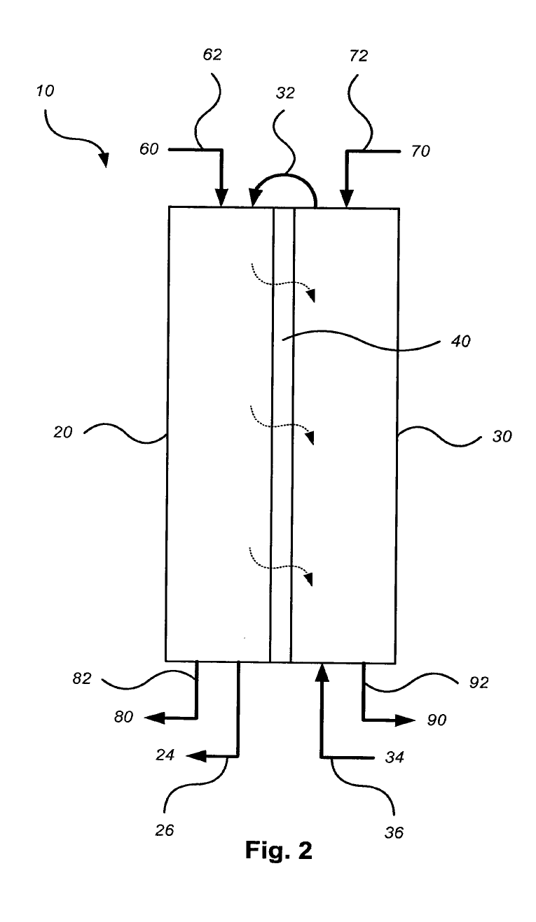

According to some exemplary implementations, as shown in FIG. 2, HDH device 50 may include supply air line 36 and exhaust air line 26 rather than dry carrier gas line 22. For example, air required to operate HDH device 50 may be provided from supply air source 34 via supply air line 36. Supply air source may be the atmosphere, stored air, or a treated air source. Supply air line 36 may feed into evaporation chamber 30. Air that is processed through HDH device 50 may be evacuated through exhaust air line 26. Exhaust air line may feed to the atmosphere, a storage area, or a treatment area.

According to some exemplary implementations, a process of operating HDH 10 is disclosed. Steam is combined with the saturated carrier gas in condensation chamber 20. The contents of condensation chamber 20 are separated into distilled water and a dry carrier gas. The distilled water is evacuated through clean water outlet line 82 or another outlet. The dry carrier gas is directed to evaporation chamber 30 through dry carrier gas line 22.

The dry carrier gas is combined with non-potable water in evaporation chamber 30. The contents of evaporation chamber 30 are separated into concentrate water and saturated carrier gas. The concentrate water is evacuated through concentrate water outlet line 92. The saturated carrier gas is directed to condensation chamber 20 through saturated carrier gas line 32.

According to some exemplary implementations, heat is transferred from condensation chamber 20 to evaporation chamber 30 through heat transfer wall 40. Heat is also circulated by the transfer of dry carrier gas from condensation chamber 20 to evaporation chamber 30. The process may be driven by heat of the steam provided by steam supply line 62. Furthermore, HDH device 10 may be operated at about atmospheric pressure.

In some exemplary implementations, in addition to inherently lower capital costs due to its all-plastic manufacture, the unique process disclosed herein is driven entirely by ambient pressure steam rather than electricity. Its operating costs are therefore much lower than conventional desalination technologies as well. When co-located at a source of waste heat, its operating costs can approach nearly zero, since the energy driving the process is virtually free in such locations. The thousands of mega-watt-hours of low temperature, near-ambient pressure steam that are currently rejected as waste heat by generating stations, CSP installations, and industrial plants throughout the U.S. represent a vast amount of non-potable water that could be desalinated for near-zero operating costs using the HDH process.

According to some exemplary implementations, HDH processes are highly energy efficient—desalinating over 3 gallons of water for the energy that would normally make 1 gallon of water by conventional thermal distillation. Conventional thermal distillation (simple boiling, followed by recondensing) requires 1,050 BTUs/pound of water, or 8,750 BTUs/gal of water—or, in metric units—˜292,000 KJoules/cubic meter of water. However, by using inexpensive plastics to separate the evaporation and condensation steps in the process by only 200 microns—the thickness of just two human hair diameters—the process recaptures such heat three times over in a simple plastic heat exchange process—thereby reducing the above heat to only 97,300 KJoules/cubic meter of water (2,900 BTUs/gal of water).

As an example, a typical 500 MW generating station rejects approximately 12,000 MWH of energy each day. Even if only half of that waste heat was utilized in the disclosed process, it could power the HDH process to make 222,000 cubic meters of water (6,000 MWH×3.6 KJoules/WH×1 cubic meter/97,300 KJoules=222,000 cubic meters), or 58 million gallons of water (180 acre-feet) per day. And this example 500 MW plant represents just 0.06% of the current U.S. steam-turbine-driven generating capacity of 460,000 MW, so the potential for the volume of low-cost water desalination is huge (300,000 acre-feet/day from just the waste heat of U.S. steam-driven electric generating stations). The steam entering a plant's cooling towers represents massive amounts of low temperature (˜100° C.) near-ambient pressure waste heat, and a fraction of it could be diverted to drive the HDH process. Three times the volume of clean distilled water results from the HDH process, as the amount of steam used, so that one-third of the distilled water would be returned to the plant's steam boiler—with the remaining two-thirds available as clean usable water.

In large quantities (groups, trains, arrays, string and line arrays and the like), the disclosed towers operating as HDH devices provide clean potable water, they help conventional power plants save water and energy in three distinct ways: (i) power plants currently have to deal with cooling tower “blow-down water”—water that becomes high in salt content due to evaporation in the cooling towers—and the on-site presence of the HDH process is ideally suited to such high-TDS water treatment; (ii) the physical act of extracting waste heat to drive the HDH process actually reduces the size of the cooling towers needed by the power plant, which saves both cost and additional input water needed by the plant, in addition to the desalinated water made by the disclosed towers, and (iii) the water thus saved represents both a reduced energy load and cost savings from not having to pump and transport as much water to the plant—and less energy means less water.

In some exemplary implementations there is disclosed a solar-powered water desalination plant, totally “off the grid”, either stand-alone with concentrated thermal solar collection, or by co-locating the HDH process along with a CSP electric power-generating field installation above a source on inland brackish water.

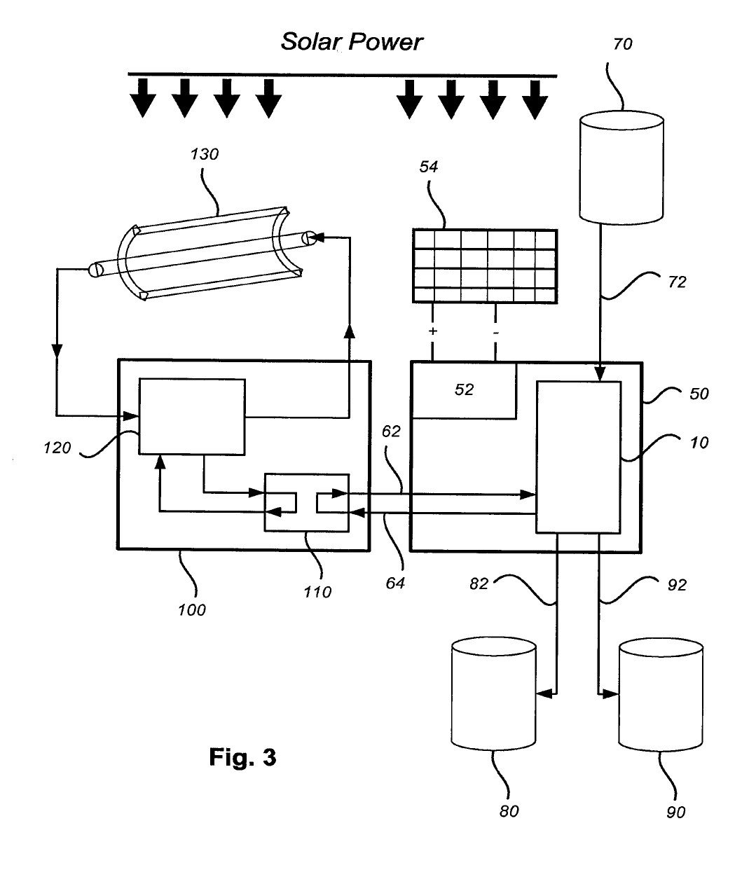

According to some exemplary implementations, as shown in FIG. 3, a system including humidification/dehumidification device 10 operates entirely on solar power. Solar-powered thermal heating device (“STHD”) 130 heats a transfer fluid. STHD 130 may contain a concentrated solar power (“CSP”) component, such as parabolic mirrors. The transfer fluid may circulate or follow a path. The transfer fluid may be provided to hot fluid storage 120 and exchange heat with steam for steam supply line 62 via heat exchanger 110. According to some exemplary implementations, the transfer fluid directly exchanges heat with steam for steam supply line 62. According to some exemplary implementations, STHD 130 directly heats steam for steam supply line 62.

According to some exemplary implementations, steam is provided by steam supply line 62 to HDH device 10 of HDH system 50. Operation of HDH device 10 is driven by steam and the heat thereof According to some exemplary implementations, other steam-driven distillation devices may be used in place of HDH device 10, such as multi-stage flash distillation devices, vapor-compression desalination devices, and multiple-effect distillation devices.

According to some exemplary implementations, non-potable water supply line 72 connects non-potable water source 70 to HDH device 10. Clean water outlet line 82 connects HDH device 10 to clean water reservoir 80. At least a portion of the clean water is directed to clean water reservoir 80, and another portion is directed to heat exchanger 110 or otherwise channeled to connect with steam supply line 62. This portion of the clean water is reheated to further drive operation of HDH device 10.

Concentrate water outlet line 92 connects HDH device 10 to concentrate water reservoir 90. Concentrate water contains contaminants from the non-potable water, but in higher concentration, rendering containment or transportation thereof more accessible and economical.

According to some exemplary implementations, non-potable water supply line 72 connects non-potable water source 70 to HDH device 10. Non-potable water may be generated by waste heat source 200 or co-located therewith.

HDH system 50 may include components 52, such as controllers, pumps, and blowers. According to some exemplary implementations, components 52 powered entirely by solar-powered photovoltaic device 54. Thereby, no external electrical power supplies are required other than STHD 130 and solar-powered photovoltaic device (“SPD”) 54.

According to some exemplary implementations, the ability of an HDH system 50 to operate by only STHD 130 and/or SPD 54 allows it to be co-located with a non-potable water source without requiring an electrical power supply. The HDH system 50 may be independently operated without connection to an electrical grid. Furthermore, HDH system 50 may be scalable, by either increasing operating capability or by combining multiple HDH device 10 or HDH systems 50.

The new generations of utility-scale CSP power generation plants suffer the same Carnot-limited heat engine conversion efficiencies that conventional fossil fuel and nuclear power plants suffer. Co-locating the HDH process at these sites will allow the same use of free, low-grade waste-heat generated by CSP. Such “co-generation” of both CSP electric power and clean water is especially beneficial because the typical CSP desert locations make their use of cooling tower water even more precious in the arid southwest. In addition, CSP units—devoid of their electric generation steam turbines and generators—could also be used with HDH desalination to solely power water desalination in remote locations such as military installations or Indian reservations that have brackish water but no access to the electrical grid.

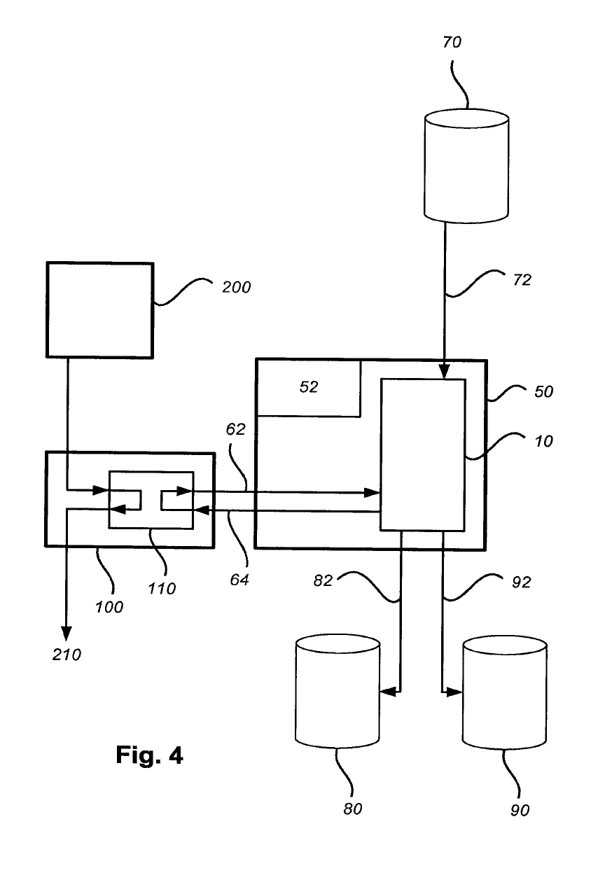

According to some exemplary implementations, as shown in FIG. 4, a system including humidification/dehumidification device 10 operates entirely on waste heat. Waste heat source 200 heats a transfer fluid. Waste heat source 200 may a power plant or any facility operating a process in which heat is generated. The waste heat is not usable or used by the process that created it. The transfer fluid may flow from waste heat source 200 or circulate in a closed-loop path. The transfer fluid may exchange heat with steam for steam supply line 62 via heat exchanger 110. According to some exemplary implementations, waste heat source 200 directly heats steam for steam supply line 62.

HDH system 50 may include components 52, such as controllers, pumps, and blowers. According to some exemplary implementations, components 52 are powered by external power, power shared with waste heat source 200, or independently solar-power.

According to some exemplary implementations, as shown in FIG. 4, spent stream 210 may include transfer fluid or steam/water that is no longer contains enough heat to drive HDH device 50. Spent stream 210 may be directed to a cooling tower, a disposal unit, a storage unit, or to waste heat source 200 for recycling, reuse, or reheating.

According to some exemplary implementations, the ability of an HDH system 50 to operate by only waste heat source 130 allows it to be co-located with a facility that includes the waste heat source and non-potable water source 70. For example, waste heat source 130 may be from the facility, and HDH system 50 may be between the facility and a cooling tower designed to dissipate heat from the facility. By further example, non-potable water source 70 may be a portion of the facility that generates non-potable water, which may be remediated by HDH system 50. Additional energy needs, if any, may be provided by the facility, for example, where the facility is a power plant.

Spent steam from a power plant into plastic HDH towers, followed by optimization of process parameters to generate maximum volumes of desalinated water from that steam's low-grade energy. This disclosure will design, build, and operate two real-world power plant demonstrations by capturing ˜1.0 MBTUs/hour of low-pressure steam exiting the steam turbines of both a conventional power plant and a CSP solar field installation, and then supplying that steam to 10 HDH plastic desalination towers at each location. Each HDH tower is capable of desalinating 400 gallons of water per day. When optimized, each tower should therefore deliver ˜4,000 gallons a day of pure distilled water, of which ˜1,500 gallons per day can flow back to the plant's boiler to make up for the steam extracted at the cooling towers. The ARS-4000 tower units are “shovel-ready” now, requiring only the integration of spent steam from outside the ARS-4000 and optimization of its 5 operational flow rates (air, steam, brackish water, concentrate water, and distilled water).

The HDH process is unique compared to former paradigms of water desalination understanding. The integrated electric generation/water remediation co-generation technology demonstrated in this disclosure will have significant and transformational impact on identified ARPA-E missions once implemented in the installed base of U.S. electric power generation.

According to some exemplary implementations, recycling facilities disclosed have a modular system design in which production capacity may be added to a fixed plant size. Each module 700 has all the piping, blowers, pumps, and tanks needed to process a given unit of PW. Steam is provided separately by a boiler system.

Each module 700 has a plurality (e.g., 12) of humidification/dehumidification (“HDH”) distillation towers 631. The recycling facility then has a number of distillation towers 631 dependent upon the number of modules 700. Each module and tower may be identical in design, and each processes the produced water utilizing identical methodology.

The system treats produced water through the use of an evaporation/condensation process. In simple terms, the system removes pure water from high-TDS water, resulting in readily usable, near-potable quality water that can be used or sold by the plant operator in whatever method is desired. As with all recycling operations, the system is a waste reduction process, meaning there is a resultant byproduct that has been reduced to 20% of the original volume delivered to the facility. This remaining 20% residual byproduct may be removed from the facility and disposed of through conventional produced water disposal methods.

The actual recycling rate is dependent upon the chemical make-up and salt concentration of the entering produced water. The salt concentration in the produced water lowers the partial pressure, at a given temperature, of the water contained in the produced water. Subsequently, the evaporation rates are lowered as salt concentration increases. Since the process concentrates the produced water during the operation, the actual recycling rate obtained will vary dependent upon the total salt concentration in the initial produced water introduced into the facility. In general, this reduction in evaporation rate will average about 20% compared to the rate obtained when recycling relatively clean water.

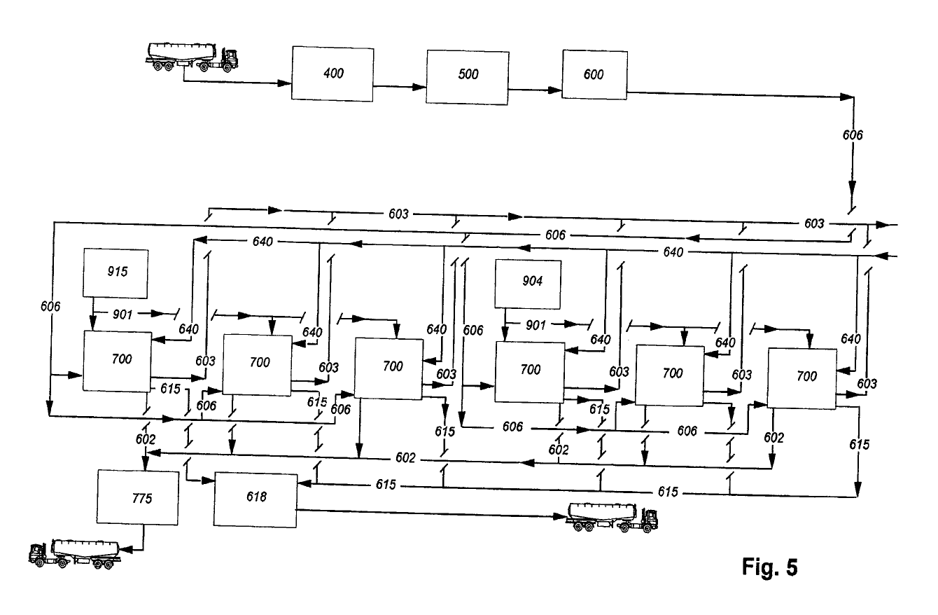

FIG. 5 shows the overall flow of the plant. According to some exemplary implementations, trucks deliver produced water and fill the raw PW tanks 400. Tank 400 feeds pretreatment system 500, which then yields produced water (“PW”) at PW tank 600. Pretreatment system 500 may include one or more of oil-water separation, chemical (oxidation, ph balance) treatment, flocculation, incline plate clarifier systems, sludge thickener systems, dewatering via filter press, multi-media filtration, inter alia.

Module 700 is the basic unit by which the disclosed process can increase a plant's treatment capacity. According to some exemplary implementations, module 700 is composed of any number of distillation towers 631 along with all associated blowers, pumps, and transfer tankage needed to support towers 631.

Module 700 inputs include: steam 901 (from boiler system 915 or another steam source); produced water 606 (water stored in PW treatment tanks 600 that has gone through the pre-treatment flow); air 640 (outside, ambient air input). Module 700 outputs are: concentrated water 615 (water treated by module 700 that is returned to PW treatment tank 600 or concentrated water storage 618); distilled water 602 (stored at distilled water storage 775); and exhaust (or saturated) air 603.

According to some exemplary implementations, as shown in FIG. 5, a plurality of modules 700, each having a plurality of towers 631, may connect to one of each type of input and output line connection. As such, the plurality of modules 700 are operated based on one type of main input or output of each type.

A description of module and tower operation is explained below for an individual module; the process applies to all modules and all towers installed in the recycling facility, according to some exemplary implementations.

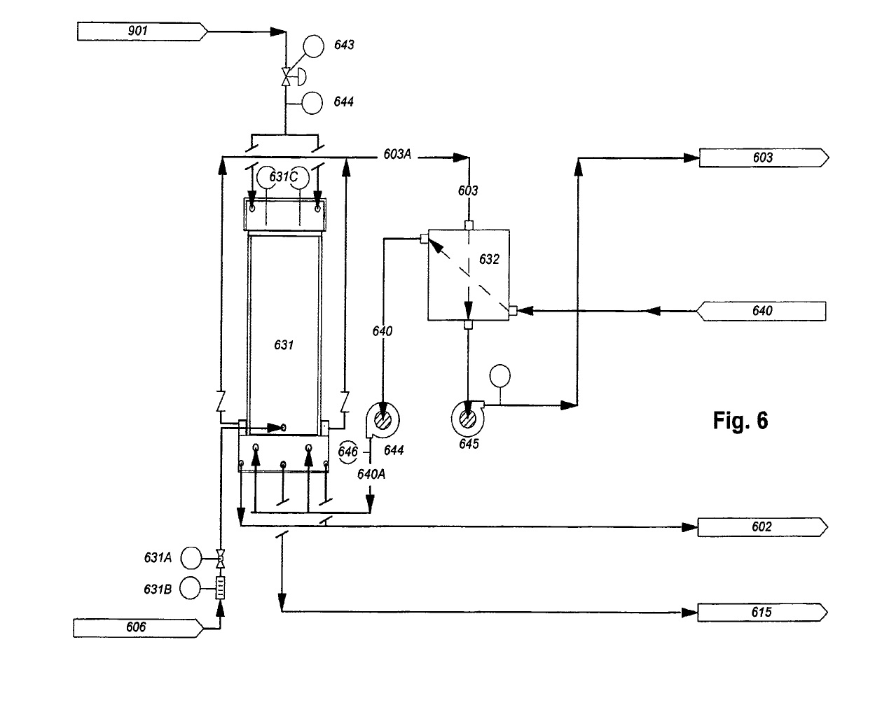

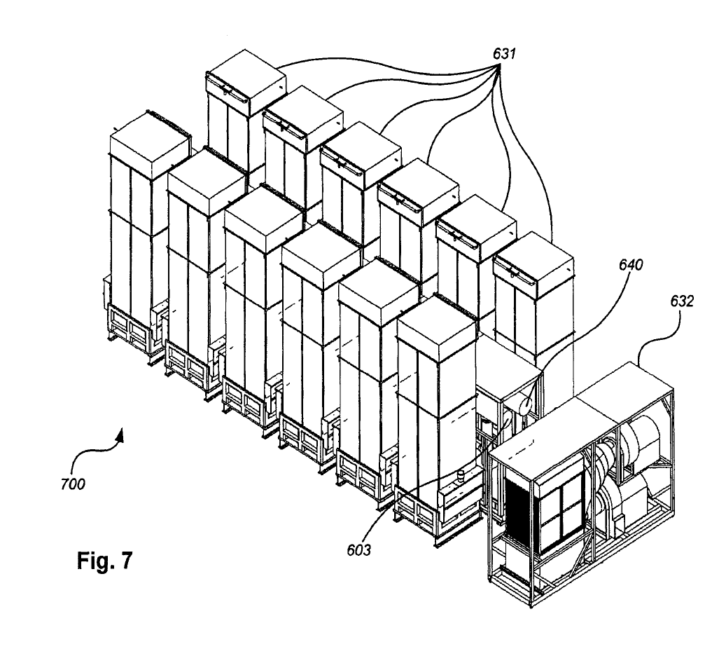

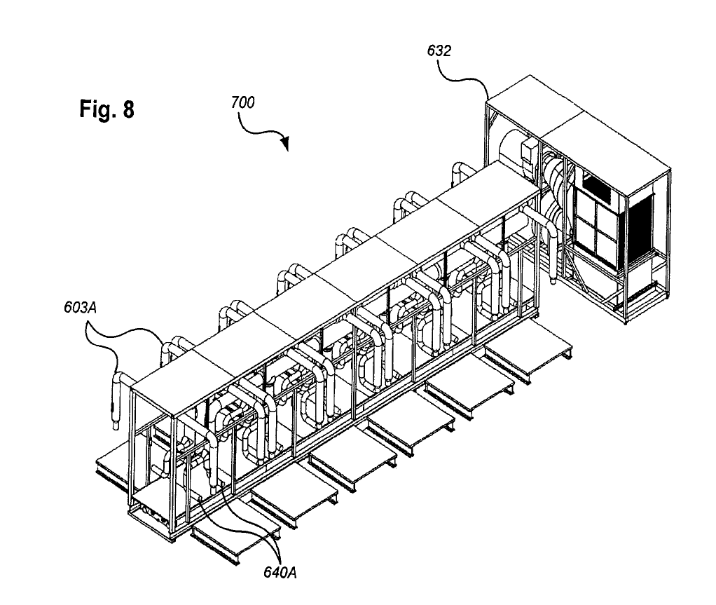

According to some exemplary implementations, as shown in FIG. 6, each tower 631 has input and output lines that correspond to the input and output lines of each module 700. As shown in FIGS. 7 and 8, modules 700 may be designed as a multi-tower unit that handle all of the input and output streams.

According to some exemplary implementations, as shown in FIG. 6, produced water 606 is pumped to each tower 631 of modules 700 via transfer pumps. This PW 606 flows through a manifold that distributes the PW to each tower 631. The produced water flow to each individual tower 631 is manually controlled via control valve 631A and flow indicator 631B. Following the flow control valve, the produced water enters tower 631, where a portion of clean water is distilled from the produced water. According to some exemplary implementations, the produced water flow in each tower 631 is controlled to maintain a produced water temperature, measured at the top of the tower by gauge 631C, of 170 to 200 degrees F.

According to some exemplary implementations, the process may require a supply of fresh air in order to work. The air may be required to drive the evaporation of water out of the produced water solution. Supply air 640 is delivered to towers 631 utilizing supply air blower 644. Supply air 640 is pre-heated through the use of an air-to-air heat exchanger (HEX) 632. For example, a cross-flow heat exchanger helps transfer the heat energy in the hot, humid exhaust air stream 603A into the cooler supply air stream 640. Supply air 640 enters each tower 631 under slight positive pressure. The air is then distributed through tower 631 to maximize the evaporation process. Sensor 646 determines if blower 644 is operating. This is sensed by the control system. If blower 644 fails, the control system shuts the module off

According to some exemplary implementations, the disclosed process is a thermal process, meaning heat drives the evaporation of the water from the produced water. Steam 901 is supplied to each tower to provide the required energy needed to drive the evaporation process. A low pressure steam boiler system may be utilized to generate the steam required by the towers. The raw steam is introduced into each tower to drive the distillation process. Each tower has a manual steam flow control 643 and a pressure gauge 644 on the tower side of the steam pipe. The plant operator manually sets the steam pressure to maximize tower efficiency.

According to some exemplary implementations, a percentage of the water in the PW is evaporated in each pass. The remaining water has all the salt of the initial PW but reduced volume. Thus it is more concentrated, and is referred to as concentrate water (“CW”). During the process, PW 606 enters and CW 615 exits each tower. In its entirety, the plant cycles the PW multiple times until the concentration of salt in the CW reaches the desired level.

According to some exemplary implementations, CW 615 that is generated in each individual pass flows out of the tower basin via gravity into a CW transfer basin. All the CW from all towers in a module may be collected into the same CW basin 618; each module has its own CW transfer basin.

According to some exemplary implementations, some of the evaporated water distills in the tower and exits the tower through DW catch basins. The DW 602 that is generated in each individual pass flows out of the tower basin via gravity into DW basin 775.

According to some exemplary implementations, supply air 640 is used to evaporate some of the water in the PW. Some of that water condenses out, while some remains in the air. This humid air is saturated with water vapor and exits the tower through one of two DW catch basins located at the bottom sides of the tower. The exhaust air 603A is exhausted from the tower using blower 645 which draws the air through air-to-air heat exchanger 632 to pre-heat supply air 640. Pressure sensor 647 tells the control system that the blower is working. If it detects a zero or low-pressure situation, the control system notifies the plant operator and shuts the module down. After exiting the heat exchanger, the air is exhausted to the atmosphere through an exhaust stack of appropriate height, which is the responsibility of the plant operator.

According to some exemplary implementations, as shown in FIGS. 6, 7, and 8, each tower 631 has a corresponding exhaust air stream 603A and supply air stream 640A. The streams for each tower converge and combine (e.g., via a manifold) to connect to main exhaust air stream 603 and main supply air stream 640 corresponding to module 700.

According to some exemplary implementations, the plurality of exhaust air streams 603A converging to main exhaust air stream 603 are provided to heat exchanger 632. Heat accrued by exhaust gasses from towers 631 is transferred to incoming gasses of main supply air stream 640. Having received the heat, main supply air stream 640 divides into separate exhaust air streams 603A for each tower 631.

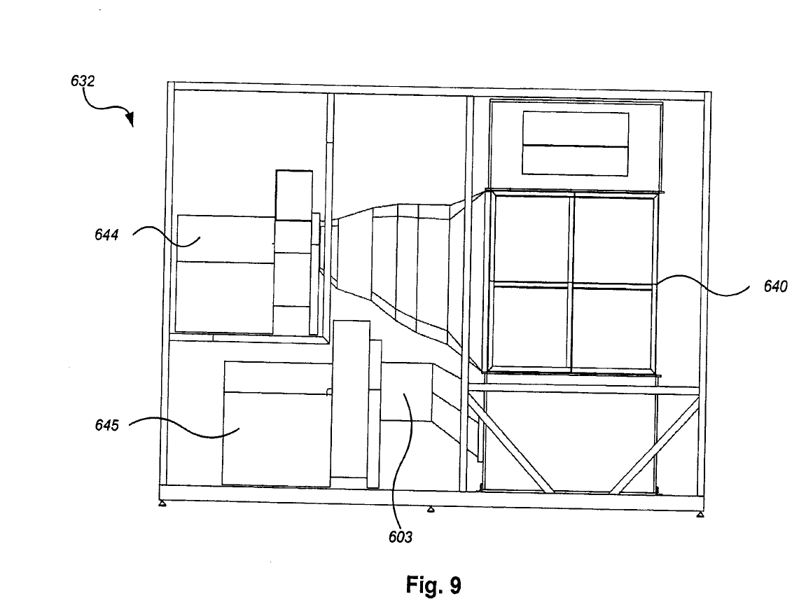

According to some exemplary implementations, as shown in FIGS. 8 and 9, heat exchanger 632 may incorporate at least portions of each of main exhaust air stream 603, main supply air stream 640, blower 645, and blower 644, as well as corresponding sensors and controllers.

Accordingly, heat exchange for exhaust and supply air is performed at the module level, rather than at the tower level. This allows a plurality of towers to operate to provide scalable performance characteristics without requiring the towers themselves to be scaled. Further, only one heat exchanger is required per module, rather than per tower. This reduces initial expenditures relating to production of heat exchanges, connections, blowers, pumps, gauges, monitors, controllers, etc. that would otherwise be required to provide one heat exchanger per tower. Additionally, operating costs are reduced. Whereas heat exchangers and support components for every tower would incur great operating costs, by operating components at a module level, fewer components are required to be used to support multiple towers.

Experimental data was compiled from modular systems using 12 towers per module. A system without a heat exchanger heating air from 32° F. to 175° F. used far more energy that a system heating exhaust air from the towers from 140° F. to 175° F.

TABLE 1

| | Energy Used per | % of |
|---|---|---|
| | Module (BTUs/hour) | Total (%) |
| Steam energy supplied to the module | 4,000,000 | 100.0% |
| to power thermal distillation process | | |
| Without heat exchanger, energy | 875,675 | 21.9% |
| required to heat the module's air from | | |
| 32° F. to 175° F. | | |
| With heat exchanger, energy | 116,424 | 2.9% |
| required to heat the module's air from | | |
| 140° F. to 175° F. | | |
| Energy saved with the heat exchanger | 759,251 | 19.0% |

As shown, the percentage of total energy used by the module for heating air is reduced from 21.9% of total consumption to 2.9% of total consumption. Expressed in terms of cost savings, the following was determined:

TABLE 2

| | | % of |
|---|---|---|
| | Results | Total (%) |
| Amount of natural gas required to make the steam | 4.0 | 100.0% |
| energy supplied to the module to power the thermal | | |
| distillation process, (MCF/hour) | | |
| Cost of natural gas required to make the steam | $16.00 | 100.0% |
| energy supplied to the module to power the thermal | | |
| distillation process @ $4/MCF, ($/hour) | | |
| Amount of natural gas saved by using the heat | 0.8 | 19.0% |
| exchanger, (MCF/hour) | | |
| Cost of natural gas saved by using the heat | $3.04 | 19.0% |
| exchanger, ($/hour) | | |

Further, the following was determined with regard to impact on a module and plant level:

TABLE 3

| | Cost ($) |
|---|---|
| Cost of natural gas saved by using the heat exchanger, | $26,604 |
| $/year/module | |
| Cost of natural gas saved by using the heat exchanger, | $106,417 |
| $/year/plant (4 modules) | |

While the method and agent have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular implementation, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative implementations.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A system comprising:
a solar-powered thermal heating device configured to transfer heat from captured solar power to a steam source;
a humidification/dehumidification device configured to distill non-potable water into clean water;
a steam supply line connecting the steam source to the humidification/dehumidification device;
a non-potable water source connected to the humidification/dehumidification device by a non-potable water supply line;
a clean water reservoir connected to the humidification/dehumidification device by a clean water outlet line;
a concentrate water reservoir connected to the humidification/dehumidification device by a concentrate water outlet line.

2. The system of claim 1, wherein the humidification/dehumidification device further comprises at least one of a controller, a pump, and a blower.

3. The system of claim 2, wherein the at least one of a controller, a pump, and a blower are powered by a solar-powered photovoltaic device.

4. The system of claim 1, further comprising a high-temperature fluid storage device configured to transfer heat from a fluid of the solar-powered thermal heating device to the steam source via a heat exchanger.

5. The system of claim 1, wherein the humidification/dehumidification device comprises:
a condensation chamber;
an evaporation chamber;
a heat transfer wall between the condensation chamber and the evaporation chamber.

6. The system of claim 5, wherein:
the steam supply line is connected to the condensation chamber;
the non-potable water supply line is connected to the evaporation chamber;
the clean water outlet line is connected to the condensation chamber;
the concentrate water outlet line is connected to the evaporation chamber.

7. The system of claim 6, further comprising:
a dry carrier gas line connecting an outlet of the condensation chamber with an inlet of the evaporation chamber;
a saturated carrier gas line connecting an outlet of the evaporation chamber with an inlet of the condensation chamber.

8. The system of claim 6, further comprising:
a saturated carrier gas line connecting an outlet of the evaporation chamber with an inlet of the condensation chamber;
a supply air line connected to the evaporation chamber;
an exhaust air line connected to the condensation chamber.

9. The method of claim 1, wherein the system is co-located with a non-potable water source having no electrical power supply.

10. A method comprising:
co-locating a humidification/dehumidification device with a non-potable water source having no electrical power supply;
collecting heat from a solar-powered thermal heating device to generate steam;
providing the steam and non-potable water from the non-potable water source to the humidification/dehumidification device;
operating the humidification/dehumidification device with the steam, whereby the non-potable water is separated into distilled water and concentrate water.

11. The method of claim 10, wherein operating the humidification/dehumidification device comprises:
combining the steam with a saturated carrier gas in a condensation chamber of the humidification/dehumidification device;
generating the distilled water and a dry carrier gas;
combining the dry carrier gas with the non-potable water in an evaporation chamber of the humidification/dehumidification device;
generating concentrate water and the saturated carrier gas.

12. The method of claim 11, wherein operating the humidification/dehumidification device further comprises:
transferring at least some of the heat from the condensation chamber to the evaporation chamber.

13. The method of claim 11, wherein the humidification/dehumidification device is operated at about atmospheric pressure.

14. The method of claim 11, wherein the method is performed by a system operating exclusively on solar power.

15. A system comprising:
a waste heat source configured to transfer waste heat to a steam source;
a humidification/dehumidification device configured to distill non-potable water into clean water;
a steam supply line connecting the steam source to the humidification/dehumidification device;
a non-potable water source connected to the humidification/dehumidification device by a non-potable water supply line;
a clean water reservoir connected to the humidification/dehumidification device by a clean water outlet line;
a concentrate water reservoir connected to the humidification/dehumidification device by a concentrate water outlet line.

16. The system of claim 15, wherein the humidification/dehumidification device comprises:
a condensation chamber;
an evaporation chamber;
a heat transfer wall between the condensation chamber and the evaporation chamber.

17. The system of claim 16, wherein:
the steam supply line is connected to the condensation chamber;
the non-potable water supply line is connected to the evaporation chamber;
the clean water outlet line is connected to the condensation chamber;
the concentrate water outlet line is connected to the evaporation chamber.

18. The system of claim 17, further comprising:
a dry carrier gas line connecting an outlet of the condensation chamber with an inlet of the evaporation chamber;
a saturated carrier gas line connecting an outlet of the evaporation chamber with an inlet of the condensation chamber.

19. The system of claim 17, further comprising:
a saturated carrier gas line connecting an outlet of the evaporation chamber with an inlet of the condensation chamber;
a supply air line connected to the evaporation chamber;
an exhaust air line connected to the condensation chamber.

20. The method of claim 15, wherein the system is co-located with a facility that includes the waste heat source and the non-potable water source.

21. A method comprising:
co-locating a humidification/dehumidification device with a facility that includes a waste heat source and a non-potable water source;
collecting waste heat from the waste heat source to generate steam;
providing the steam and non-potable water to the humidification/dehumidification device.
operating the humidification/dehumidification device with the steam, whereby the non-potable water is separated into distilled water and concentrate water.

22. The method of claim 21, wherein operating the humidification/dehumidification device comprises:
combining the steam with a saturated carrier gas in a condensation chamber of the humidification/dehumidification device;
generating the distilled water and a dry carrier gas;
combining the dry carrier gas with the non-potable water in an evaporation chamber of the humidification/dehumidification device;
generating concentrate water and the saturated carrier gas.

23. The method of claim 22, wherein operating the humidification/dehumidification device further comprises:
transferring at least some of the heat from the condensation chamber to the evaporation chamber.

24. A module for distillation, comprising:
a plurality of distillation towers configured to distill clean water from non-potable water;
a main supply air line connected to a supply air line of each of the plurality of distillation towers;
a main exhaust air line connected to an exhaust air line of each of the plurality of distillation towers;
a heat exchanger configured to exchange heat between the main exhaust air line and the main supply air line.

25. The module of claim 24, wherein each of the plurality of distillation towers comprises:
a condensation chamber;
an evaporation chamber; and
a heat transfer wall between the condensation chamber and the evaporation chamber;
a steam supply line connected to the condensation chamber;
a non-potable water supply line connected to the evaporation chamber;
a clean water outlet line connected to the condensation chamber;
a concentrate water outlet line connected to the evaporation chamber;
saturated carrier gas line connecting an outlet of the evaporation chamber with an inlet of the condensation chamber;
the supply air line connected to the evaporation chamber;
the exhaust air line connected to the condensation chamber;

26. A method, comprising:
providing supply air to a module having a plurality of distillation towers;
separating the supply air among the plurality of distillation towers;
in each of the plurality of distillation tower, generating distilled water, concentrate water, and exhaust air from produced water, steam, and the supply air;
combining the exhaust air from the plurality of distillation towers;
transferring heat from the exhaust air to the supply air.

27. The method of claim 26, wherein the generating step comprises:
combining the supply air with the produced water in an evaporation chamber of the distillation tower;
generating the concentrate water and a saturated carrier gas;
combining the steam with the saturated carrier gas in a condensation chamber of the distillation tower;
generating the distilled water and the exhaust air.
